(19) United States
(12) Patent Application Publication
(10) Pub. No.: US 2025/0007708 A1
(43) Pub. Date: Jan. 2, 2025

(54) CONNECTABLE ELECTRONIC MODULE COMPRISING CLUSTERS OF SECURE ELEMENTS

(71) Applicant: IDEMIA FRANCE, Courbevoie (FR)

(72) Inventors: Yannick COURQUIN, Courbevoie (FR); Vincent BOURDARAUD, Courbevoie (FR)

(73) Assignee: IDEMIA FRANCE, Courbevoie (FR)

(21) Appl. No.: 18/755,801

(22) Filed: Jun. 27, 2024

(30) Foreign Application Priority Data
Jun. 29, 2023 (FR) 2306916

(51) Int. Cl. H04L 9/08

(52) U.S. Cl. CPC H04L 9/088

(57) ABSTRACT

Electronic module able to be connected to a host device, said electronic module comprising:
one or more clusters of secure elements, each of the secure elements of one and the same cluster being connected to a common communication bus associated with said cluster;
an electronic module controller configured, on the one hand, to communicate with the host device and with the common communication bus of each of the clusters and, on the other hand, to control the execution of cryptographic operations by one or more secure elements;
wherein:
   the module controller is furthermore configured to allocate one or more secure elements of one or more clusters to one or more authenticated clients, each of the secure elements allocated to each authenticated client locally storing a unique master cryptographic key specific to each of said authenticated clients;
   each of the secure elements allocated to each of the authenticated clients implements a cryptographic operation using a cryptographic key specific to each of the allocated secure elements;
   each of the secure elements allocated to each of the authenticated clients is configured to decrypt the input data of the cryptographic operation and/or to encrypt the output data of the cryptographic operation using the unique master cryptographic key.

### TECHNICAL FIELD

The present invention relates to a connectable electronic module comprising clusters of secure elements.

### TECHNICAL BACKGROUND

It is common to use hardware security modules (HSM) in the form of physical or virtual computing devices that offer cryptographic functions for the execution of certain tasks, such as:
managing, importing, exporting and saving cryptographic keys;
processing encrypted data, for example decrypting data or executing digital signature functions;
offloading application servers to perform symmetric or asymmetric cryptographic operations.

Hardware security modules provide a specific interface restricted only to users or entities authorized to inspect the data that they generate and access the data stored therein.

When they are implemented in network architectures, the modules are generally in the form of embedded cryptographic cards equipped with a communication interface, for example a PCMCIA, PCI, PCI-Express, USB or SCSI/IP communication interface.

U.S. Pat. No. 9,355,280 B2 [BROADCOM CORP [US]] 31 May 2016 describes an integrated circuit comprising a hardware security module implementing a secure area for storing a unique key of a device. The secure area makes it possible to prevent unauthorized access to the unique key. The module comprises a secure processor for encrypting and decrypting data within the secure area, and a secure interface for communicating the decrypted data to external resources.

EP 3 663 945 A1 [IDEMIA France [FR]] 10 Jun. 2020 describes an electronic module able to be connected to a host device comprising a module controller configured to communicate with the host device, and one or more clusters of secure elements connected, within one and the same cluster, to a common bus that connects them to the module controller. The module controller is configured to convert a cryptographic operation into a plurality of similar elementary cryptographic tasks using different information and to control the execution of the elementary cryptographic tasks by the secure elements. Such an electronic module is flexible and scalable. Its cryptographic processing and storage capabilities may be adjusted by adding new certified secure elements to an existing cluster or in the form of a new cluster, without the need to renew its certification.

Various hardware security modules may be interconnected within one and the same distributed computing environment. By way of illustrative example, within a network, one or more hardware security modules may communicate with an application server or network interface via which said hardware security modules are interfaced with distinct services. The application server acts as a gateway that sorts and manages network service requests with a view to having them executed by the one or more hardware security modules.

It is common to provide hardware security modules as services in a cloud computing infrastructure hosted by a computing resources provider. The hosted hardware security modules may be allocated dynamically with various software architectures, for example a multi-tenant architecture or else a virtualization architecture in which they are provided in the form of virtual hardware security modules. Once allocated, they may be managed and operated remotely by clients of the infrastructure. WO 2014/159750 A1 [AMAZON TECH INC [US]] 2 Oct. 2014 describes a computer-implemented method for adding, at the request of a client whose network is hosted with a computing resources provider, one or more hardware security modules to the network of said client. The modules are selected from among a plurality of hardware security modules available from said provider, and are added and managed via a communication interface. The identifiers of the hardware security modules allocated to each client are stored in a database.

WO 2015/069460 [MOTOROLA SOLUTIONS INC [US]] 14 May 2015 describes a method for providing hardware security modules as services in a cloud computing solution. A computer cloud based on a hardware security module architecture is first segmented into a plurality of virtual hardware security modules. What is referred to as a source virtual hardware security module, containing an initial set of authentication information and roles, is selected from among the plurality of virtual hardware security modules and then allocated to each cloud application. A service controller directs requests from each cloud application, which are then directed to the corresponding allocated virtual hardware security module. The allocation and access to virtual hardware security modules are managed according to the resource needs of the cloud. The user of each virtual module may also prevent other users and the cloud computing solution provider from accessing said user's own resources.

WO 2016/099644 A1 [PRIVATE MACHINES INC [US]] 23 Jun. 2016 describes a method for managing hardware security modules. Each module comprises a cryptographic processor and is initialized by loading a private key and a certificate of the public key. When the hardware security modules are allocated to a client, said hardware security modules prove their knowledge of the private key, and their public key certificate is verified. Each hardware security module authenticated for allocation is then reconfigured, and identification information is communicated to the client to which it is allocated.

US 2020 045028 A1 [AMAZON TECH INC [US]] 6 Feb. 2020 describes a method for managing a fleet of hardware security modules implemented in a cloud computing infrastructure for virtualization-based provision of virtual hardware security modules. The size of the fleet may be adapted according to the use of the resources of the fleet, without impacting clients interacting with the virtual hardware security modules.

### SUMMARY OF THE INVENTION

### Technical Problem

A major drawback of current solutions for the provision of hardware security modules as services in a cloud computing infrastructure, whether implemented with a multi-tenant architecture or a virtualization architecture, is that it cannot be guaranteed that keys and other data that are stored and/or generated by a client in one or more physical modules are isolated from those of other clients, stored and/or generated in the same modules, and that these other clients are not able to access them.

The principle of a multi-tenant architecture or of a virtualization architecture is that of pooling, that is to say sharing, computing resources in order to optimize the management thereof and reduce the operating costs thereof. In this type of architecture, in order to isolate the data stored and/or generated by each client using a pooled software and/or hardware resource, for example a physical or virtual hardware security module, it is common to authenticate access to said resource, to erase the data therefrom at the end of a session once they have been processed there, and/or store the data in physically or virtually distinct databases specific to each client. However, because the resource is pooled, these operations all fail to certify, or prove, that a physical hardware security module is allocated to a single client and/or that the data stored and/or generated therein are physically isolated from those of other clients that have access to said module.

Now, a common use of cloud infrastructures is that of exchanging, between clients of the infrastructure, sensitive information access to which may be regulated by strict policies relating to its protection and its confidentiality. For example, a public authority or a state institution, a certification body or a banking establishment may need to protect or generate certain information, such as cryptographic keys and certificates, in order to authenticate and secure connections, via in particular SSL/TLS protocols, on their platforms in order to exchange or store personal or confidential information, or else to validate financial transactions. In some cases, in particular for the exchange of data requiring a very high level of confidentiality, and for which it is necessary to certify isolation from third parties, the current solutions for providing hardware security modules as services may therefore not be suitable. Another drawback of the solutions may be their lack of flexibility and scalability in terms of managing the physical resources of the infrastructure according to the needs of users. For example, in the event of an additional demand for resources to execute cryptographic operations, it may be necessary to add one or more physical hardware security modules to the infrastructure. Such an addition requires purchasing new hardware and maintenance operations on the infrastructure. In addition to costs, this may lead to temporary unavailability of some equipment of the infrastructure.

Therefore, there is still a need for a solution for providing increased protection for data stored and/or generated by clients using hardware security modules provided as services in a cloud computing infrastructure. This solution will make it possible to meet confidentiality and security requirements when exchanging certain sensitive information. Ideally, it will also be able to be flexible and scalable so as to facilitate the management of the physical resources of the infrastructure.

### Technical Solution

In a first aspect of the invention, provision is made for a connectable electronic module as described in claim 1, the dependent claims being advantageous embodiments.

In a second aspect of the invention, provision is made for a system comprising an electronic module according to a first aspect of the invention.

In a third aspect of the invention, provision is made for a method for configuring an electronic module according to the first aspect of the invention.

In a fourth aspect of the invention, provision is made for a method for processing data in an electronic module according to the first aspect of the invention.

In a fifth aspect of the invention, provision is made for a program comprising instructions that, when the program is executed by a data processing unit, cause the latter to implement the steps of a method according to the third or fourth aspect of the invention.

In a sixth aspect, provision is made for an information medium able to be read by a data processing unit and comprising instructions that, when executed by a data processing unit, cause said processing unit to implement the steps of a method according to the third or fourth aspect of the invention.

In a seventh aspect, a description is given of the use of an electronic module according to the first aspect of the invention in a cloud electronic infrastructure, in particular in a cloud electronic infrastructure implemented with a single-tenant or multi-tenant architecture, or with a virtualization architecture.

### Advantages

One noteworthy advantage of the invention is that of providing the possibility of providing secure elements as services within a cloud computing infrastructure without compromising the confidentiality and protection of the data of clients of the cloud. The invention solves the problems inherent to pooling resources and makes it possible to allocate secure elements to each client in an exclusive manner while preserving the physical association between the secure elements and the client. It thus guarantees compliance with the principle of data isolation between the clients of the infrastructure.

It is thus possible to prove unequivocally that a particular secure element is assigned to a particular client, and any other third-party client is not able to access said element or the data that it contains or processes. Even in the event of an incident such as corruption of the data or of the master cryptographic key by a third party or by a defective allocated secure element, or even the data being accessed accidentally by a non-allocated secure element or another authenticated client, the data remain unusable and the secure elements cannot function correctly.

Another advantage of the invention is that of offering a flexible and scalable solution for optimum management of the physical resources of the infrastructure that allows a high level of personalization, in particular with regard to the number of allocated secure elements, for each client. In a cloud computing infrastructure, it is possible to dynamically allocate secure elements according to needs of clients.

### BRIEF DESCRIPTION OF THE DRAWINGS

FIG. 1 is a schematic depiction of one example of an electronic module.

FIG. 2 is a schematic depiction of an electronic module according to the first aspect of the invention.

FIG. 3 is a schematic depiction of a detail of FIG. 2.

FIG. 4 is a schematic depiction of an electronic module according to some embodiments of the first aspect of the invention.

### DETAILED DESCRIPTION OF EMBODIMENTS

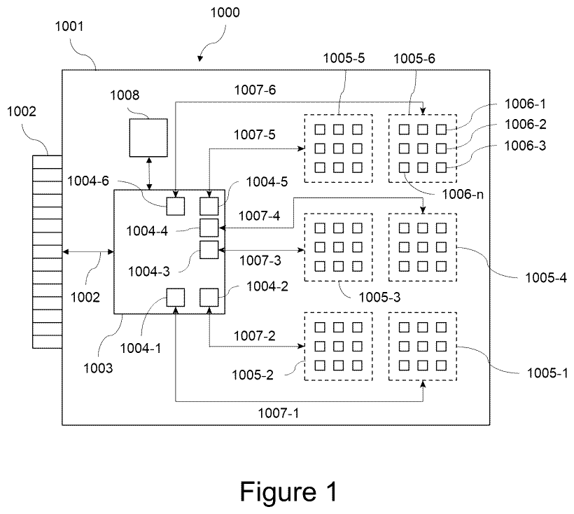

With reference to FIG. 1, taken from EP 3 663 945 A1 [IDEMIA France [FR]]10 Jun. 2020, one example of an electronic module 1000 comprises an electronic card 1001, a connection means 1002 for connection to a host device, a module controller 1003, a communication bus 1002 connecting the connection means 1002 to the module controller 1003, one or more clusters 1005-1; . . . ; 1005-6, each comprising a plurality of secure elements 1006-1; . . . ; 1006-n connected, within one and the same cluster 1005-1; . . . ; 1005-6, to one and the same bus 1007-1; . . . ; 1007-6, which connects them to the module controller 1003, and a volatile main memory 1008. By way of example, the connection means 1002 for connection to a host device may be a PCI or else PCI-Express interface. The volatile main memory 1008 may be a random access memory (RAM). The bus 1007-1; . . . ; 1007-6 connecting a cluster 1005-1; . . . ; 1005-6 to the module controller 1003 may be an SPI, I2C, I3C, ISO or UART bus. The module controller 1003 may then comprise a communication interface 1004-1; . . . ; 1004-6 for each cluster 1005-1; . . . ; 1005-6. The communication bus 1002 may be a PCI, PCI-Express, I2C or else I3C communication bus. The module controller 1003 may be a programmable controller, such as a field-programmable gate array (FPGA) controller. It may support conventional application programming interfaces (API) for communicating with the host device, for example PKCS #11, Open SSL, MS CAPI, Java JCE/JCA application programming interfaces.

Each of the secure elements 1006-1; . . . ; 1006-n generally complies with security standards such as FIPS 140-3/4, ISO/IEC 19790:2012, ISO/IEC 24759:2017, ISO/IEC 15408:2022, CC: 2022 EUAL 4+, and/or energy efficiency standards such as MEPS. In fact, the electronic module 1000 may be certified as complying with one or more of these standards. By way of example, the secure elements 1006-1; . . . ; 1006-n may be security controllers, universal integrated circuit cards (UICC) or embedded universal integrated circuit cards (eUICC).

The host device may for example be a server comprising a processing unit and one or more electronic modules 1000.

For the execution of cryptographic tasks, the communication between the module controller 1003 and the secure elements 1006-1; . . . ; 1006-n of each cluster 1005-1; . . . ; 1005-6 may be asymmetric communication, for example master/slave communication. Each secure element 1006-1; . . . ; 1006-n of a cluster 1005-1; . . . ; 1005-6 then behaves as a slave with respect to the module controller.

The size of the clusters 1005-1; . . . ; 1005-6, that is to say the number of secure elements 1006-1; . . . ; 1006-n per cluster, is generally conditional upon the capacity of the communication interfaces 1004-1; . . . ; 1004-6. By way of example, the number of secure elements 1006-1; . . . ; 1006-n of a cluster may be less than or equal to the ratio between the duration of a digital processing operation, such as an encryption, of a data packet of given size by a given secure element and the transmission duration of the packet on the communication bus 1007-1; . . . ; 1007-6. Optimizing the bandwidth between each communication interface 1004-1; . . . ; 1004-6 and the corresponding cluster 1005-1; . . . ; 1005-6 of secure elements 1006-1; . . . ; 1006-n makes it possible to minimize the number of communication interfaces 1004-1; . . . ; 1004-6.

The clusters 1005-1; . . . ; 1005-6 may be of identical size or of different sizes, that is to say comprise an identical or different number of secure elements 1006-1; . . . ; 1006-n. Preferably, each cluster 1005-1; . . . ; 1005-6 comprises one and the same number of secure elements 1006-1; . . . ; 1006-n in order to simplify the management of the secure elements 1006-1; . . . ; 1006-n by the module controller 1003.

To execute a cryptographic operation at the request of the host device, the module controller 1003 decomposes or converts this operation into a plurality of elementary cryptographic tasks, which it assigns to the secure elements at its disposal. These cryptographic tasks may be executed in parallel by the secure elements, in particular by multiplexing commands.

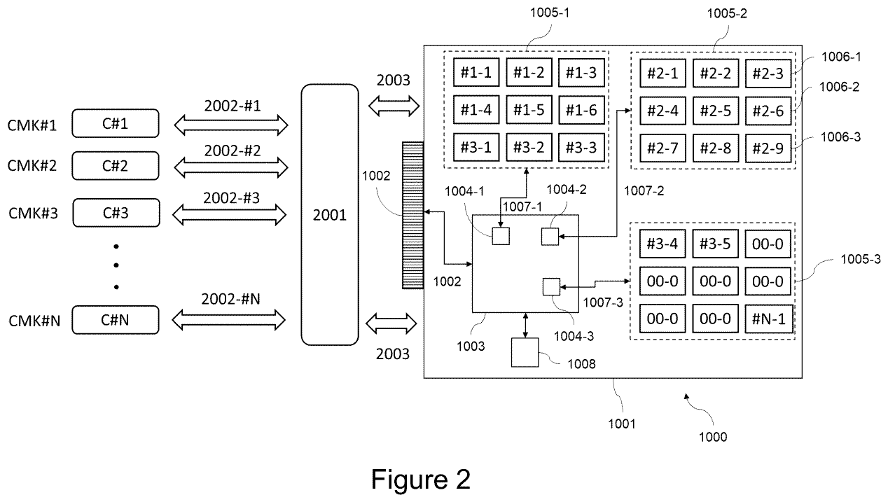

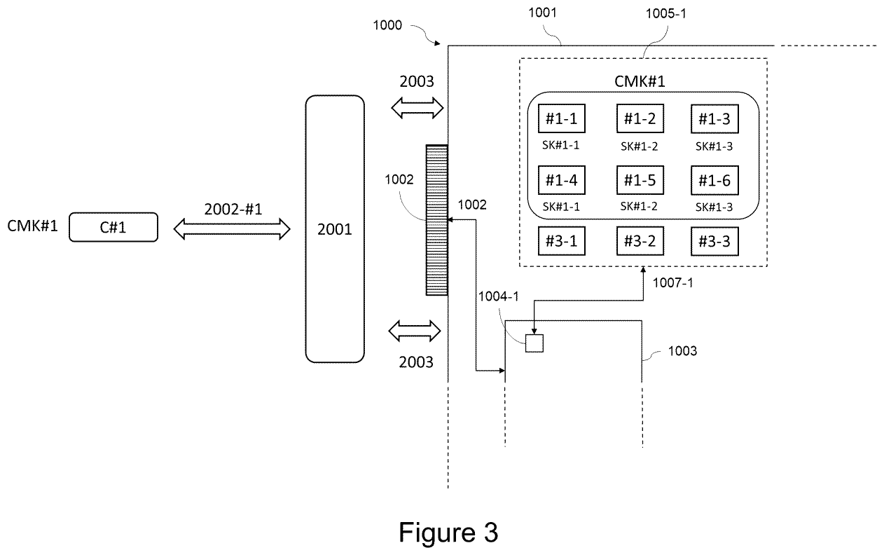

In a first aspect of the invention, with reference to FIG. 1, FIG. 2 and FIG. 3, provision is made for an electronic module 1000 able to be connected to a host device 2001, said electronic module 1000 comprising:
one or more clusters 1005-1; . . . ; 1005-6 of secure elements 1006-1; . . . ; 1006-6, each of the secure elements 1006-1; . . . ; 1006-6 of one and the same cluster 1005-1; . . . ; 1005-6 being connected to a common communication bus 1007-1; . . . ; 1007-6 associated with said cluster 1005-1; . . . ; 1005-6;
an electronic module controller 1003 configured, on the one hand, to communicate with the host device 2001 and with the common communication bus 1007-1; . . . ; 1007-6 of each of the clusters 1005-1; . . . ; 1005-6 and, on the other hand, to control the execution of cryptographic operations by one or more secure elements 1006-1; . . . ; 1006-6;
   wherein:
the module controller 1003 is furthermore configured to allocate one or more secure elements #1-1; . . . ; #N−1 of one or more clusters 1005-1; . . . ; 1005-6 to one or more authenticated clients C#1; . . . ; C#N, each of the secure elements #1-1; . . . ; #N−1 allocated to each authenticated client C#1; . . . ; C#N locally storing a unique master cryptographic key CMK #1; . . . ; CMK #N specific to each of said authenticated clients C#1; . . . ; C#N;
each of the secure elements #1-1; . . . ; #N−1 allocated to each of the authenticated clients C#1; . . . ; C#N implements a cryptographic operation OC using a cryptographic key SK-#1-1; . . . ; SK #N−1 specific to each of the allocated secure elements #1-1; . . . ; #N−1;
each of the secure elements #1-1; . . . ; #N−1 allocated to each of the authenticated clients C#1; . . . ; C#N is configured to decrypt the input data DE of the cryptographic operation OC and/or to encrypt the output data DS of the cryptographic operation OC using the unique master cryptographic key CMK #1; . . . ; CMK #N. For the sake of clarity, only some of the clusters and secure elements from FIG. 1 are shown in FIG. 2 and FIG. 3.

A “client” is understood to mean a hardware or software element that sends requests to access a service available on a server via a network. The client may be a thin client or a thick client. In particular, it may be a computer or a program. The concept of a client may, by extension, cover both the hardware or software element and the natural person operating said element.

An “authenticated client” is understood to mean a client whose identity has been previously registered in the form of a signature or certificate, and whose identity is verified, upon each connection to the host device or electronic module, by way of a suitable authentication method. Preferably, the authentication is a strong multi-factor authentication (“MFA”), for example a two-factor authentication (“2FA”), in particular using a physical token, such as a software token, for example, a short text message (“SMS”), push notifications, or a hardware token, for example a token with a dynamic password, an asynchronous token, a token with a contact-based or contactless security element, such as a chip card, a USB key, a Bluetooth key, an RFID key or an NFC key, storing cryptographic keys, electronic signatures or biometric information about the natural person associated with the client. Once the client has been authenticated and connected, digital tokens, for example Web tokens or cookies, may be used to maintain authentication during the connection session. When a connection 2002-#1; . . . ; 2002-#N is established between the authenticated client and the host device 2001 and/or electronic module 1000, this connection 2002-#1; . . . ; 2002-#N is generally secured, for example using SSL/TLS protocols. Depending on use, the connection 2002-#1; . . . ; 2002-#N may also be an SSH connection. It may also be established via a VPN.

A “cryptographic operation” or “cryptographic task” is understood to mean an operation of generating a cryptographic key, an encryption or decryption operation, and/or an operation of storing one or more cryptographic keys. Cryptographic operations may implement various types of cryptographic algorithms, such as DES (Data Encryption Standard), 3DES (Triple DES), AES (Advanced Encryption Standard), RSA (Rivest, Shamir and Adelman), ECC (Elliptic Curve Cryptography), MD5 (Message Digest 5), SHA-1 (Secure Hash Algorithm 1), SHA-2, SHA-3 or else MAC.

According to the invention, the control module 1003 is configured to allocate one or more secure elements #1-1; . . . ; #N−1 of one or more clusters 1005-1; . . . ; 1005-6 to one or more authenticated clients C#1; . . . ; C#N, each of the secure elements #1-1; . . . ; #N−1 allocated to each authenticated client C#1; . . . ; C#N locally storing one and the same unique master cryptographic key CMK #1; . . . ; CMK #N specific to each of said authenticated clients C#1; . . . ; C#N.

In FIG. 2, the secure elements allocated to a client are numbered #X-Y, the references #X and Y corresponding respectively to the identifier of the client #X, X being equal to 1 to N, and to the number Y of the secure element in the one or more clusters. The secure elements referenced 00-0 are not allocated. By way of illustrative example, the secure elements #1-1 to #1-6 of the cluster 1005-1 are allocated to the client C#1 and store the same unique master key CMK #1, all six secure elements #2-1 to #2-9 of the cluster 1005-2 are allocated to the client C#2 and store the same unique master key CMK #2, the secure elements #3-1 to #3-5 of the clusters 1005-1 and 1005-3 are allocated to client C#3 and store the same unique master key CMK #3, and the secure element #N−1 of the cluster 1005-3 is allocated to the client C#N and stores the same unique master key CMK #N.

The number of secure elements #1-1; . . . ; #N−1 allocated to each authenticated client C#1; . . . ; C#N may be defined beforehand by the client itself according to its needs, or by a computing resources provider hosting the host device 2001, and therefore one or more electronic modules 1000.

The secure elements #1-1; . . . ; #N−1 allocated to each client may be identified C#1; . . . ; C#N in a database BDD-1 in which the identifier of each allocated secure element #1-1; . . . ; #N−1 is associated with an identifier of the client C#1; . . . ; C#N to which it is allocated. This database BDD-1, which is preferably encrypted, may be stored in the host device 2001 or, preferably, in the module controller 1003. According to some alternative or additional embodiments, each allocated secure element #1-1; . . . ; #N−1 may store, preferably in its secure enclave, the identifier or a cryptographic fingerprint of the client C#1; . . . ; C#N to which it is allocated. This identifier, or its cryptographic fingerprint, may then be communicated with the instructions and/or the data transmitted by the module controller 1003 to the allocated secure modules #1-1; . . . ; #N−1 for the execution of a cryptographic operation OC. The allocated secure modules #1-1; . . . ; #N−1 may be configured to verify the identity of the client C#1; . . . ; C#N, or its cryptographic fingerprint, before executing the requested cryptographic operation OC.

These embodiments are particularly advantageous in that they provide an additional level of security. For example, when instructions from an authenticated client are likely to be sent by mistake, for example following a hardware or software anomaly, to secure elements that are not allocated to said authenticated client, only secure elements that have authenticated the origin, that is to say the client, of the instructions will execute the instructions. These embodiments may also be advantageous for implementing “broadcast” communication of instructions during use of the electronic module; secure elements that have not authenticated their origin will not execute the instructions.

At the time when the secure elements 1006-1; . . . ; 1006-6 are allocated by the module controller 1003, one and the same unique master cryptographic key CMK #1; . . . ; CMK #N specific to each authenticated client C#1; . . . ; C#N is stored locally in each of the allocated secure elements #1-1; . . . ; #N−1. For security reasons, this same unique master cryptographic key CMK #1; . . . ; CMK #N is preferably stored in read-only mode in the secure enclave of each allocated secure element #1-1; . . . ; #N−1, such that it is not able to be communicated outside the secure element. It may be stored in a manner encrypted by a specific key specific to each allocated secure element #1-1; . . . ; #N−1, which is itself stored in a secure enclave, which will decrypt it at the time when it requires it for a cryptographic operation OC.

The specific unique master cryptographic key CMK #1; . . . ; CMK #N stored in the one or more secure elements #1-1; . . . ; #N−1 allocated in step (b) may be defined using any suitable procedure. Preferably, this definition may be implemented in the form of a key ceremony (KC), preferably in accordance with the standards “Statement on Auditing Standards no.70”, (SAS70), “Statement on Standards for Attestation Engagements No. 16 (SSAE 16)” and/or else “International Standard on Assurance Engagements 3402 (ISAE 3402)”. Optionally, a portion of the unique master key defined in the ceremony may be defined by the client to which the secure elements are allocated.

By its very nature, the unique master cryptographic key CMK #1; . . . ; CMK #N specific to each authenticated client C#1; . . . ; C#N is known only to the secure elements #1-1; . . . ; #N−1 allocated to the client C#1; . . . ; C#N, and cannot be exported outside the allocated secure elements. It constitutes a common cryptographic key that may serve as means for identifying the secure elements #1-1; . . . ; #N−1 allocated to a given authenticated client C#1; . . . ; C#N. For example, with reference to FIG. 2, the unique master cryptographic key CMK #1 specific to the authenticated client C#1 is known only to the allocated secure elements #1-1; . . . ; #1-6, and cannot be exported outside only these allocated secure elements #1-1; . . . ; #1-6.

According to the invention, each of the secure elements #1-1; . . . ; #N−1 allocated to each authenticated client C#1; . . . ; C#N implements a cryptographic operation using a cryptographic key SK-#1-1; . . . ; SK #N−1 specific to each secure element #1-1; . . . ; #1-6. This specific key SK-#1-1; . . . ; SK #N−1 may be generated using any appropriate cryptographic algorithm, for example AES or DES. By way of illustrative example, the secure elements #1-1; . . . ; #1-6 allocated to the client C#1 respectively have their own specific cryptographic key SK-#1-1; . . . ; SK-#1-6. The specific cryptographic key SK-#1-1 is specific to each allocated secure element #1-1; . . . ; #1-6 and is known only to them.

According to some embodiments, said specific cryptographic key SK-#1-1; . . . ; SK #N−1 is derived from said unique master cryptographic key CMK #1; . . . ; CMK #N specific to each of the authenticated clients C#1; . . . ; C#N. For example, each of the secure elements #1-1; . . . ; #1-6 allocated to the client C#1 derives their respective specific cryptographic key SK-#1-1; . . . ; SK-#1-6 from the unique master cryptographic key that is common to them and specific to the client C#1. The derivation may be derived using any appropriate derivation function, for example a hash function or derivation functions compliant with the ISO 18033 and PCKS #5 standards. It may also be a proprietary derivation function certified as complying with the security standards in force.

According to some advantageous embodiments, the secure elements #1-1; . . . ; #N−1 allocated to an authenticated client C#1; . . . ; C#N may be organized according to an asymmetric communication or control model, in particular according to a master-slave relationship. With reference to FIG. 2, one of the secure elements, for example the secure element #1-1 from among those #1-1; . . . ; #N−1 allocated to an authenticated client C#1; . . . ; C#N, may be defined as a master secure element, the other allocated secure elements #1-2; . . . ; #1-6 being defined as slaves. This type of organization may be advantageous for the execution of cryptographic operations requiring the resources of multiple secure elements in parallel or in series. The execution of some cryptographic operations may be delegated by the module controller 1003 to the slave secure element that is responsible for their deployment to the slave secure elements. The master secure element may then validate a cryptographic operation and/or segment it into elementary operations, and then forward it to the slave secure elements for execution.

This organization according to a master/slave model is also advantageous for the maintenance of the secure elements, such as a configuration change or update of the secure elements allocated to a client. For example, the client may request a change of encryption algorithm, or else an update to the operating system of the secure elements. This request may first be validated and executed by the master secure element, which will then transmit it to the slave secure elements in order to replicate the same change.

According to some embodiments, when the identifier, or a cryptographic fingerprint, of the client is used to authenticate the origin of the instructions, this authentication operation may also be assigned to just the master secure element, thus reducing the workload of the slave secure elements.

In a master/slave model, the common master cryptographic key may advantageously be used by the master secure element as a means for identifying the slave secure elements allocated to one and the same authenticated client with which said master cryptographic key is associated. In a communication between the master secure element and the other secure elements, the secure element may verify, for example via comparison of a cryptographic fingerprint such as a hash, that the secure elements with which it is communicating share the same common master cryptographic key, and therefore that they belong to the same “family” or “farm” of secure elements allocated to one and the same authenticated client.

According to the invention, each of the secure elements #1-1; . . . ; #N−1 allocated to each of the authenticated clients C#1; . . . ; C#N is configured to decrypt the input data DE of the cryptographic operation OC and/or to encrypt the output data DS of the cryptographic operation OC using the unique master cryptographic key CMK #1; CMK #N. The data exchanged between the authenticated client and the secure elements allocated thereto are thus never communicated in “clear”, that is to say in unencrypted form, and only allocated secure elements having the same common master cryptographic key are able to decrypt them. Confidentiality is therefore perfectly preserved. Thus, in the event for example of external corruption of the data or of the master cryptographic key by a third party or by a defective allocated secure element, or even the data being accessed accidentally by a non-allocated secure element or another authenticated client, the data remain unusable.

According to some advantageous embodiments, the secure elements 1006-1; . . . ; 1006-6 are secure elements of one and the same cluster of secure elements 1005-1; . . . ; 1005-6. According to the invention, the secure elements of one and the same cluster are connected to one and the same common communication bus. Within one and the same cluster, communication between allocated secure elements, for example in a master/slave model, and/or with the module controller may be more optimum with less latency. The module controller 1003 is also relieved from having to manage and schedule instructions between the allocated secure elements distributed into different clusters.

The secure elements, and possibly the module controller, may comprise application programming interfaces (API) allowing third-party client applications to request the execution of cryptographic operations by the electronic module. Preferably, these interfaces comply with the PCKS #11 standard, also called “cryptoki”, and/or the PCKS #15 standard.

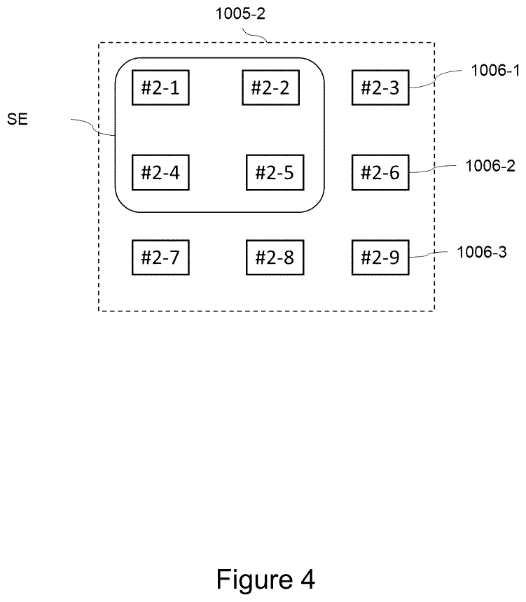

According to some embodiments, with reference to FIG. 4, the module controller 1003 is configured, for one or more authenticated clients C#1; . . . ; C#N, to control the execution of the cryptographic operation OC by a subset SE of secure elements chosen from among the secure elements #1-1; . . . ; #N−1 allocated to said authenticated clients C#1; . . . ; C#N.

By way of illustrative example, with reference to FIG. 4, a subset SE comprising the secure elements #2-1; #2-2; #2-4 and #2-5 of the authenticated client C#2 is controlled by the module controller (not shown) so as to execute the cryptographic operation OC.

The number of secure elements in the subset SE may be defined in various ways. It may be defined by the host device or the module controller 1003 depending on the complexity of the cryptographic operations to be executed or the overall load of the electronic module when multiple cryptographic operations are to be executed at the request of the clients. It may also be defined by the master secure element when the allocated secure elements are organized according to a master/slave model. In all of these cases, the number of secure elements may be advantageously adapted for better management of the resources of the electronic module.

The number of secure elements in the subset SE may also be defined by the client C#1; . . . ; C#N itself, via the host device 2001 or the module controller 1003 according to rules established beforehand by the client on the basis of the nature and complexity of the cryptographic operations. This embodiment may be advantageous in order to relieve the host device 2001, the module controller 1003 and/or the master secure elements from such management, and therefore lighten the load on the electronic module.

According to some additional embodiments, the module controller 1003 is configured, for one or more authenticated clients C#1; . . . ; C#N, to control the execution of a plurality of cryptographic operations OC by subsets SE of secure elements chosen from among the secure elements #1-1; . . . ; #N−1 allocated to said authenticated clients C#1; . . . ; C#N, each of the cryptographic operations OC being respectively executed by one of the subsets SE of secure elements, and the number of secure elements of each of the subsets being defined by said authenticated clients C#1; . . . ; C#N.

These embodiments are particularly advantageous when the authenticated client requires only a limited number, for example two or three, of secure elements to execute an operation or wishes to assign different cryptographic operations to the secure elements allocated to said client. For example, among the set of allocated secure elements, the client may want a subset SE comprising a given number, for example two or three, of secure elements to be assigned to the generation of cryptographic keys, while another subset SE of another number of secure elements should be assigned to the encryption of a dataset. This allows the simultaneous execution of a plurality of cryptographic operations through optimum management of the allocated secure elements, and a reduction in the processing time of the set of cryptographic operations. This results in a time saving for the client.

According to some embodiments in addition to those above, the cryptographic operations OC are executed in parallel and/or in series by each of the subsets SE of secure elements. The secure elements of each subset may operate in series and/or parallel.

By way of example, a client wishes to simultaneously encrypt series of two different datasets with two different cryptographic keys. For this purpose, each dataset of a series may be transmitted to two different subsets SE, each of the subsets generating a key and then encrypting the dataset with the generated key. Within a subset SE, a secure element may operate in series with the other secure elements that operate in parallel. The series secure element may then be a master secure element configured to generate a cryptographic key and segment the encryption operations into sub-operations that the parallel secure elements, which are then slaves, then execute using the generated cryptographic key transmitted to them beforehand.

According to some embodiments, the allocated secure elements #1-1; . . . ; #N−1 are configured to locally internally store the results of one or more cryptographic operations OC. These results may be cryptographic keys or encrypted and/or decrypted data, which will then be made available for further processing by allocated secure elements #1-1; . . . ; #N−1 or the module controller 1003.

According to some embodiments, the module controller 1003 is configured to communicate with at least one database BDD and/or at least one third-party application APP associated with an authenticated client. The database BDD may be located in the module controller 1003 itself, in the host device 2001 or in remote hardware associated with the authenticated client. The third-party application APP may be any type of application that requires the result of a cryptographic operation to run, process a transaction or a dataset.

By way of illustrative example, the third-party application APP may be an application that requires authentication of a client authenticated using a digital fingerprint. The application may then, via the module controller 1003, transmit the digital fingerprint at its disposal to one or more allocated secure elements #1-1; . . . ; #N−1 which, using a cryptographic operation OC, will compare it with the digital fingerprint of a specific cryptographic key at their disposal that was used previously to register the authenticated client with said application APP. If the digital fingerprints match, the module controller 1003 returns a validation output signal to the application APP, and the application APP is able to run. If the digital fingerprints do not match, the module controller 1003 returns a non-validation output signal to the application APP, and the application APP does not run.

It is common for one or more cryptographic keys to be used recurrently for encryption and decryption operations, for example in repeated symmetric or asymmetric cryptographic operations. Rather than generating these keys upon each operation or each session of authenticated clients, it is more convenient and economical, for sound management of computing resources, to store them in a dedicated non-volatile memory space and to retrieve them as needed. Now, by nature, secure elements have a limited non-volatile local memory. The number of cryptographic keys able to be stored therein is therefore very limited. Furthermore, storing them in a secure element is not optimum because the stored keys are able to be used only by said secure element. When said secure element is not available, for example when it is assigned to another cryptographic operation, said keys are not accessible and cannot be used by another secure element.

Therefore, according to some embodiments, the module controller 1003 is configured to store the output data DS of a cryptographic operation OC carried out by one or more allocated secure elements #1-1; . . . ; #N−1 in a database BDD and/or retrieve an input datum DE from a database BDD for processing by way of a cryptographic operation OC executed by one or more allocated secure elements #1-1; . . . ; #N−1, said database BDD being associated with the authenticated client C#1; . . . ; C#N to which said secure elements #1-1; . . . ; #N−1 are allocated. These embodiments are then particularly advantageous for creating a cryptographic key store dedicated to an authenticated client. The allocated secure elements #1-1; . . . ; #N−1 of the electronic module 1000 are controlled so as to generate cryptographic keys, which, once they have been encrypted by the unique master cryptographic key CMK #1; . . . ; CMK #N associated with said allocated secure elements #1-1; . . . ; #N−1, are exported, via the module controller 1003, to a database BDD associated with the authenticated client C#1; . . . ; C#N to which said secure elements #1-1; . . . ; #N−1 are allocated. To use the cryptographic keys to encrypt or decrypt a dataset, for example, the cryptographic keys in the database BDD associated with an authenticated client C#1; . . . ; C#N are imported, via the module controller 1003, to the allocated secure elements #1-1; . . . ; #N−1. The secure elements #1-1; . . . ; #N−1 then decrypt the keys using the associated unique master cryptographic key CMK #1; . . . ; CMK #N and then execute the encryption or decryption operations using said imported cryptographic keys once they have been decrypted.

In addition to storing cryptographic keys, the database BDD may also contain other data, such as digital or biometric fingerprints, which may be subjected to cryptographic operations by the allocated secure elements.

Preferably, the clusters 1005-1; . . . ; 1005-6 of secure elements 1006-1; . . . ; 1006-6 are arranged on one or more physical media. Examples of physical media may be electronic cards with a PCI, PCI-Express, USB-A or C connection means. In particular, one and the same physical medium may comprise one or more clusters of secure elements. For ease of design, it is preferable for the elements of one and the same cluster to be on the same physical medium.

In a second aspect of the invention, provision is made for a system comprising
a host device 2001;
one or more electronic modules 1000 according to any one of the embodiments of the first aspect of the invention and connected to the host device 2001.

The host device 2001 may generally be a data processing unit, such as a client computing terminal, for example a particular computer, connected or not connected to a network, or else a computer server for offering services to remote clients.

According to some embodiments, the host device 2001 may be a server comprising a processing unit. One or more electronic modules 1000 are connected to the host device using any suitable connection means, for example a PCI, PCI-Express, USB-A or C connection means. These embodiments are particularly advantageous for implementations of the system according to the invention in a cloud electronic infrastructure, in particular in a cloud electronic infrastructure implemented with a single-tenant or multi-tenant architecture, or with a virtualization architecture. In a third aspect of the invention, provision is made for a method for configuring an electronic module 1000 according to any one of the embodiments of the first aspect of the invention. Said method comprises the following steps:
(a) registering at least one client from a list of authenticated clients C#1; . . . ; C#N;
(b) allocating, via the module controller 1003, one or more secure elements #1-1; . . . ; #N−1 of one or more clusters 1005-1; . . . ; 1005-6 of secure elements 1006-1; . . . ; 1006-6 to a single authenticated client from the list of authenticated clients C#1; . . . ; C#N;
(c) defining, via the module controller 1003, a unique master cryptographic key CMK #1; . . . ; CMK #N specific to the one or more secure elements #1-1; . . . ; #N−1 allocated in step (b);
(d) storing, locally within each allocated secure element #1-1; . . . ; #N−1, the unique master cryptographic key CMK #1; . . . ; CMK #N defined in step (c).

In step (a), a client may be registered using any suitable procedure, in particular by registering the identity of the client beforehand in the form of an electronic signature and/or an electronic certificate, and then creating electronic identifiers associated with the client for the subsequent establishment of connections to the host device 2001 or to the electronic module 1003. Upon each connection to the host device 2001 or to the electronic module 1000, the identity of the client is authenticated using an appropriate authentication method, in particular as described in the context of the first aspect of the invention.

In step (b), the number of secure elements 1006-1; . . . ; 1006-6 allocated to each client C#1; . . . ; C#N may be defined beforehand by the client itself according to its needs, or by a computing resource provider hosting the host device 2001 and the electronic module 1000.

As described above, the secure elements 1006-1; . . . ; 1006-6 allocated to each client C#1; . . . ; C#N may be identified in a database in which the identifier of each secure element is associated with an identifier of the client to which it is allocated. This database, which is preferably encrypted, may be stored in the host device 2001 or, preferably, in the module controller 1003. Also, each secure element #1-1; . . . ; #N−1 may store, preferably in its secure enclave, the identifier or a cryptographic fingerprint of the client C#1; . . . ; C#N to which it is allocated. This identifier, or its cryptographic fingerprint, may then be communicated with the instructions and/or the data transmitted by the module controller 1003 to the allocated secure modules #1-1; . . . ; #N−1 for the execution of a cryptographic operation OC. The secure modules may be configured to verify the identity of the client, or its cryptographic fingerprint, before executing the requested cryptographic operation.

In step (c), the definition, via the module controller 1003, of a unique master cryptographic key CMK #1; . . . ; CMK #N specific to one or more secure elements allocated in step (b) may be carried out using any suitable procedure. In particular, this definition may be implemented in the form of a key ceremony (KC), preferably in accordance with the standards “Statement on Auditing Standards no.70, (SAS70)”, “Statement on Standards for Attestation Engagements No. 16 (SSAE 16)” and/or else “International Standard on Assurance Engagements 3402 (ISAE 3402)”.

In step (d), the unique master cryptographic key CMK #1; . . . ; CMK #N defined in step (c) is stored locally within each allocated secure element #1-1; . . . ; #N−1. For security reasons, the unique master cryptographic key CMK #1; . . . ; CMK #N is preferably stored, in read-only mode, in the secure enclave of each allocated secure element, such that it is not able to be communicated outside the secure element #1-1; . . . ; #N−1. It may be stored in a manner encrypted by a specific key specific to each secure element, which is itself stored in a secure enclave, which will decrypt it at the time when it requires it for a cryptographic operation.

According to some preferred embodiments, steps (c) to (d) of the configuration method according to the second aspect of the invention may be implemented using a method for replicating or cloning the secure elements #1-1; . . . ; #N−1, in particular when these secure elements are structurally identical.

More precisely, once the secure elements #1-1; . . . ; #N−1 have been allocated to an authenticated client C#1; . . . ; C#N, a first secure element, called master secure element, may be selected from these, and then its configuration may be initialized, in particular by implementing the master cryptographic key CMK #1; . . . ; CMK #N defined in step (c) and the identifiers of the client where applicable. This configuration may also comprise installing and/or parameterizing specific applications, APIs and/or programs of the secure element. Once the configuration of the master secure element is complete, its configuration is exported to the rest of the secure elements, called slave secure elements. The slave secure elements then replicate or clone the received configuration under the control of the master secure element. Once the slave secure elements have completed the replication or cloning of the configuration, they return a replication or cloning process completion output signal to the master secure element. The master secure element may be configured to receive the completion output signal from each slave secure element, verify that it satisfies a certain number of criteria, and validate that the replication or cloning of the configuration of each slave secure element is consistent with its own.

According to some embodiments, the method may furthermore comprise a step, after step (d), of modifying a number of secure elements #1-1; . . . ; #N−1 allocated to said client C#1; . . . ; C#N based on a request from said client C#1; . . . ; C#N. The electronic module may thus be configured such that the client is able, according to its needs, to request the allocation of new secure elements. Ideally, when its needs are reduced, it may also give up certain secure elements that have been allocated thereto in order to make them available to other authenticated clients. The one or more secure elements thus given up by the client may then be reset, via the module controller, to their original configuration, generally called factory configuration. They are then available and ready for allocation to another client, in particular according to a replication or cloning procedure as described above.

According to a fourth aspect of the invention, provision is made for a method for processing data in an electronic module 1000 according to the first aspect of the invention, said method comprising the following steps:
(a) authenticating, via the module controller 1003, a connection of a client C#1; C#N;
(b) receiving, via the module controller 1003, from the authenticated client C#1; . . . ; C#N, a request to execute one or more cryptographic operations OC;
(c) controlling, via the module controller 1003, the execution of the cryptographic operation OC by one or more secure elements allocated to said authenticated client . . . ; C#1; . . . ; C#N;
(d) encrypting, using the unique master cryptographic key CMK #1; . . . ; CMK #N, the one or more output data DS of the cryptographic operation OC.

The method may furthermore comprise, before step (c):
(b1) receiving, via the module controller 1003, encrypted input data DE for the execution of the cryptographic operation OC;
(b2) decrypting, using the unique master cryptographic key CMK #1; . . . ; CMK #N, the received encrypted input data DE.

Depending on the communication model established between the allocated secure elements, the encryption/decryption steps of steps (b2) and (c) may be executed by one or more secure elements involved in the execution of the cryptographic operation OC controlled by the module controller 1003. For example, in the case of an organization of the allocated secure elements according to a master/slave model, the master secure element may be designated or, alternatively, it may designate one or more secure elements to decrypt the received input data DE and/or encrypt the one or more output data DS of the cryptographic operation. Alternatively, in the case of an organization of the secure elements operating in parallel, each secure element of the secure elements allocated and used for the execution of the cryptographic operation OC executes the decryption and/or encryption operations. It is also possible, for example via the module controller 1003, to designate one or more secure elements for the decryption and/or encryption operations that do not belong to those that execute the cryptographic operation of step (c).

By way of illustrative example, the processing method according to the third aspect of the invention may make it possible to generate cryptographic keys dedicated to an authenticated client, in particular in order to create a store of cryptographic keys used for other applications. The client C#1; . . . ; C#N, once it has been authenticated, requests, via the module controller 1003, the execution of a cryptographic operation OC of having multiple cryptographic keys generated by each allocated secure element #1-1; . . . ; #N−1. Each allocated secure element, under the control of the module controller 1003, then generates a cryptographic key, using any appropriate cryptographic algorithm, for example AES, DES or a derivation function applied to the unique master key. Each generated cryptographic key is then encrypted, using the unique master cryptographic key CMK #1; . . . ; CMK #N, by the secure element that generated it. The generated and then encrypted cryptographic keys may then be exported, via the module controller, to a database associated with the authenticated client.

To use the cryptographic keys to encrypt or decrypt a dataset, the cryptographic keys in the database associated with the authenticated client are imported, via the module controller, to the allocated secure elements. The secure elements then decrypt the keys using the unique master cryptographic key and then execute the encryption or decryption operations using said imported cryptographic keys once they have been decrypted.

According to a fifth aspect of the invention, provision is made for a program comprising instructions that, when the program is executed by a data processing unit, cause the latter to implement the steps of a method according to the second and/or third aspect of the invention.

Any type of compiled or interpreted programming language may be used to implement the steps of the method of the invention. The computer program may form part of a software solution, that is to say a set of executable instructions, codes, scripts or the like and/or software databases.

The data processing unit may be the host device 2001 or the module controller 1003. According to a sixth aspect of the invention, provision is made for an information medium able to be read by a data processing unit and comprising instructions that, when executed by a data processing unit, cause said processing unit to implement the steps of a method according to the second and/or third aspect of the invention. The medium able to be read by a data processing unit is preferably a non-volatile memory, for example a hard disk or a solid state drive (SSD). The computer-readable medium may be a removable storage medium or a non-removable storage medium forming part of a computer. It may also be a non-volatile memory inside a removable medium. This may make the invention easier to deploy.

The medium able to be read by a data processing unit may also form part of a terminal, or computer, used as a server from which executable instructions are able to be downloaded which, when executed by a computer, cause the computer to execute a method according to one of the described embodiments.

The medium able to be read by a data processing unit may be in the host device 2001 or the module controller 1003.

According to a seventh aspect of the invention, an electronic module 1000 according to the first aspect of the invention may advantageously be used in a cloud electronic infrastructure, in particular in a cloud electronic infrastructure implemented with a single-tenant or multi-tenant architecture, or with a virtualization architecture. In a cloud electronic infrastructure, an electronic module 1000 according to the first aspect of the invention makes it possible to provide secure elements as services to clients of the infrastructure. The secure elements allocated to a client are allocated thereto exclusively, practically physically. This particular advantage of the invention allows increased protection of data stored and/or generated by clients. The invention meets the requirements in terms of confidentiality and security when exchanging certain sensitive information, while still being flexible and scalable enough for optimum management of the physical resources of the infrastructure.

### REFERENCES

### Patent Literature

U.S. Pat. No. 9,355,280 B2 [BROADCOM CORP [US]] 16 May 2031.
EP 3 663 945 A1 [IDEMIA France [FR]] 10 Jun. 2020.
WO 2014/159750 A1 [AMAZON TECH INC [US]] 2 Oct. 2014.
WO 2015/069460 [MOTOROLA SOLUTIONS INC [US]] 14 May 2015.
WO 2016/099644 A1 [PRIVATE MACHINES INC [US]] 23 Jun. 2016.
US 2020 045028 A1 [AMAZON TECH INC [US]] 6 Feb. 2020.

### Non-Patent Literature

ISO 18033:2022, Information security—Encryption algorithms.
ISO 19790:2012, Information technology—Security techniques—Security requirements for cryptographic modules.
ISO 24759:2017, Information technology—Security techniques—Test requirements for cryptographic modules.
ISO 15408:2022, Information security, cybersecurity and privacy protection—Evaluation criteria for IT security.
FIPS 140-3, Security Requirements for Cryptographic Modules, 2019 PKCS #5, Password-Based Cryptography Specification v2.0, 2000.
PKCS #11, Cryptographic Token Interface v3.0, 2020.
PKCS #15, Cryptographic Token Information Syntax Standard, 1999.
ISO/IEC 7816-15:2016 Identification cards—Integrated circuit cards—Part 15:
Cryptographic information application.
SAS 70—Statement on Auditing Standards no.70
SSAE 16/18—Statement on Standards for Attestation Engagements No. 16/18.
ISAE 3402—International Standard on Assurance Engagements 3402
CC: 2022—Common Criteria for Information Technology Security Evaluation, CCMB-2022-11-005, 2022.

1. An electronic module configured to be connected to a host device, said electronic module comprising:
one or more clusters of secure elements, each of the secure elements of one and the same cluster being connected to a common communication bus associated with said cluster;
an electronic module controller configured, to communicate with the host device and with the common communication bus of each of the clusters and to control the execution of cryptographic operations by one or more secure elements, wherein:
the electronic module controller is further configured to allocate one or more secure elements of one or more clusters to one or more authenticated clients, each of the secure elements allocated to each authenticated client locally storing a unique master cryptographic key specific to each of said authenticated clients;
each of the secure elements allocated to each of the authenticated clients implements a cryptographic operation using a cryptographic key specific to each of the allocated secure elements; and
each of the secure elements allocated to each of the authenticated clients is configured to decrypt the input data of the cryptographic operation and/or to encrypt the output data of the cryptographic operation using the unique master cryptographic key.

2. The module according to claim 1, such that the module controller is configured, for one or more authenticated clients, to control the execution of the cryptographic operation by a subset of secure elements chosen from among the secure elements allocated to said authenticated clients.

3. The module according to claim 2, wherein the module controller is configured, for one or more authenticated clients, to control the execution of a plurality of cryptographic operations by subsets of secure elements chosen from among the secure elements allocated to said authenticated clients, each of the cryptographic operations being respectively executed by one of the subsets of secure elements, and the number of secure elements of each of the subsets being defined by said authenticated clients.

4. A module according to claim 3, wherein the cryptographic operations are executed in parallel and/or in series by each of the subsets of secure elements.

5. The module according to claim 1, wherein the allocated secure elements are configured to locally internally store the results of one or more cryptographic operations.

6. The module according to claim 1, wherein the module controller is configured to communicate with at least one database and/or at least one third-party application associated with an authenticated client.

7. The module according to claim 6, wherein the module controller is configured to store the output data of a cryptographic operation carried out by one or more allocated secure elements in a database and/or retrieve an input datum from a database for processing by way of a cryptographic operation executed by one or more allocated secure elements, said database being associated with the authenticated client to which said secure elements are allocated.

8. The module according to claim 1, wherein the clusters of secure elements are arranged on one or more physical media.

9. A system, comprising:
a host device; and
one or more of the electronic modules according to claim 1 and connected to the host device.

10. The method for configuring the electronic module according to claim 1, said method comprising:
(a) registering at least one client from a list of the authenticated clients;
(b) allocating, via the module controller, the one or more secure elements of the one or more clusters of secure elements to a single authenticated client from the list of authenticated clients;
(c) defining, via the module controller, the unique master cryptographic key specific to the one or more secure elements allocated in step (b); and
(d) storing, locally within each allocated secure element, the unique master cryptographic key defined in step (c).

11. The configuration method according to claim 10, further comprising a step, after step (d), of modifying a number of the one or more secure elements allocated to said client based on a request from said client.

12. A method for processing data in the electronic module according to claim 1, said method comprising:
authenticating, via the module controller, a connection of a client;
receiving, via the module controller, from the authenticated client, a request to execute one or more cryptographic operations;
controlling, via the module controller, the execution of the cryptographic operation by one or more secure elements allocated to said authenticated client; and
encrypting, using the unique master cryptographic key, the one or more output data of the cryptographic operation.

13. A non-transitory computer-readable medium storing a program comprising instructions that, when the program is executed by a data processing circuitry, causes the data processing circuitry to implement the steps of the method according to claim 10.

14. (canceled)

15. A method of using the electronic module according to claim 1 in a cloud electronic infrastructure implemented with a single-tenant or multi-tenant architecture, or with a virtualization architecture.
